(19) United States
(12) Patent Application Publication
(10) Pub. No.: US 2013/0228726 A1
(43) Pub. Date: Sep. 5, 2013

(54) INJECTION MOLDABLE ESD COMPOUNDS HAVING LOW TRIBO-CHARGE

(71) Applicants: Yun Zheng, Shanghai (CN); David Zou, Shanghai (CN)

(72) Inventors: Yun Zheng, Shanghai (CN); David Zou, Shanghai (CN)

(21) Appl. No.: 13/410,329

(22) Filed: Mar. 2, 2012

(51) Int. Cl. H01B 1/04; H01B 1/12

(52) U.S. Cl. 252/511; 252/500

(57) ABSTRACT

Injection moldable electrostatic discharge compositions are disclosed.

### BACKGROUND

1. Technical Field

The present disclosure relates to injection moldable electrostatic discharge compounds having low tribo-charge.

2. Technical Background

Electrostatic discharges (ESD) can be detrimental to electronic components, resulting in failures, reduced reliability and increased costs, and latent component failures in deployed equipment. When an electronic failure occurs in the field due to ESD, the cost can be significant. Conventional static dissipative polymers can be used to discharge current in a controlled and predictable fashion, typically in less than a second. The use of such static safe polymers to control ESD can reduce the risk of damage to sensitive electronic components.

Polymers are typically good insulators, but can become conductive or static-dissipative upon the addition of conductive fillers, such as, for example, carbon black, carbon fiber, metallic powder, metallic fiber, glass spheres, and glass fiber coated metals. The addition of such materials can create a network of interconnecting particles within the polymer matric, allowing electric charges to conduct through the insulating polymer.

The amount of conductive filler needed to impart a desired level of conductivity to a polymer can vary depending on the composition and morphology of a particular filler. This threshold amount of conductive filler is referred to as the percolation threshold.

There is a need for improved electrostatic discharge polymers. These needs and other needs are satisfied by the compositions and methods of the present disclosure.

### SUMMARY

In accordance with the purpose(s) of the invention, as embodied and broadly described herein, this disclosure, in one aspect, relates to injection moldable electrostatic discharge compounds having low tribo-charge.

In one aspect, the present disclosure provides an electrostatic discharge safe composition comprising a polymeric matrix; and a combination of one or more conductive fibers and one or more conductive powders.

In a second aspect, the present disclosure provides an electrostatic discharge safe composition comprising a polymer matrix of a polycarbonate, a nylon, a polypropylene, a polyethylene, a polyetherimide, a polyetheretherketone, a polyamide, and/or derivatives and combinations thereof.

In another aspect, the present disclosure provides an electrostatic discharge safe composition comprising a carbon fiber.

In another aspect, the present disclosure provides an electrostatic discharge safe composition comprising one or more conductive fibers having an aspect ratio of greater than about 10 and a diameter of from about 1 μm to about 50 μm.

In another aspect, the present disclosure provides an electrostatic discharge safe composition comprising a carbon powder.

In another aspect, the present disclosure provides an electrostatic discharge safe composition comprising one or more conductive powders comprising a furnace carbon black, a thermal black, a graphite, a Ketjenblack, a heat treated carbon black, a surface modified carbon black, or a combination thereof.

In another aspect, the present disclosure provides an electrostatic discharge safe composition comprising a conductive powder having an average primary particle size of from about 0.1 μm to about 5 μm.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying drawings, which are incorporated in and constitute a part of this specification, illustrate several embodiments of the instant invention and together with the description, serve to explain, without limitation, the principles of the invention.

FIG. 1 illustrates the tribocharge resulting from compositions having various loadings of carbon fiber, in accordance with various aspects of the present invention.

FIG. 2 illustrates the tribocharge resulting from compositions having various loadings of carbon fiber and/or carbon black, in accordance with various aspects of the present invention.

FIG. 3 illustrates the tribocharge resulting from compositions having various loadings of carbon fiber and/or carbon black, in accordance with various aspects of the present invention.

FIG. 4 is a schematic illustrating carbon fiber and carbon black dispersed in a polymer matrix, in accordance with various aspects of the present invention.

FIG. 5 illustrates the tribocharge resulting from compositions having various loadings of carbon fiber and/or carbon black, in accordance with various aspects of the present invention.

### DESCRIPTION

The present invention can be understood more readily by reference to the following detailed description of the invention, figures, and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C═C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfo-oxo group” as used herein is represented by the formulas —S(O)₂R, —OS(O)₂R, or , —OS(O)₂OR, where R can be hydrogen, an alkyl, alkenyl, alkynyl, aryl, aralkyl, cycloalkyl, halogenated alkyl, or heterocycloalkyl group described above.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides injection moldable compositions having low tribo charge. Electrostatic discharges (ESD) can be detrimental to electronic components, resulting in failures, reduced reliability and increased costs, and latent component failures in deployed equipment. Polymeric materials are typically good insulators, but can become conductive or static-dissipative upon the addition of conductive fillers, such as, for example, carbon black, carbon fiber, metallic powder, metallic fiber, glass spheres, and glass fiber coated metals. The addition of such materials can create a network of interconnecting particles within the polymer matric, allowing electric charges to conduct through the insulating polymer.

Electrostatic discharge is the result of static electricity that can be created by a process known as tribocharging. Tribocharging can occur when two materials are brought into contact and then separated. The friction between the two materials can result in tribocharging, creating electrical potential differences that can lead to a discharge. Such discharges can release enormous amounts of energy, capable of damaging or destroying sensitive electronic components.

To prevent or reduce the likelihood of an electrostatic discharge, materials in the vicinity of electronic components can be made conductive and be grounded. Similarly, contact with packaging materials during, for example, shipping, can result in tribocharging. Thus, packaging materials used for sensitive electronic components should be conductive or exhibit a low tribocharge.

In one aspect, the prevention of ESD can be controlled using conductive or semi-conductive materials. Such static dissipative materials can have surface resistivity values in the range of 10⁵ to 10¹¹ ohm-meters. The present disclosure provides polymer based compositions that can provide controlled conduction of charge and thus, reduce and/or eliminate the likelihood of an ESD event.

In one aspect, the accumulation of tribocharge on a material can be controlled or adjusted through the surface resistivity and/or volume resistivity or the material. With respect to surface resistivity, values of from about 10³˜10⁵ to about 10⁸ Ω/sq are deemed static-dissipative, whereas values less than about 10³˜10⁵ Ω/sq are deemed conductive. For effective ESD protection and tribocharge decay, lower surface resistivity values are generally desired.

In one aspect, the inventive ESD safe composition comprises a polymeric matrix and a combination of a conductive fiber and a conductive powder dispersed within the polymeric matrix. In another aspect, the ESD safe composition has a surface resistivity suitable for use in a static-dissipative application. In yet another aspect, the ESD safe composition is not electrically conductive. In other aspects, the ESD safe composition does not have a surface resistivity of less than about 10⁵ Ω/sq or 10³ Ω/sq).

### Polymeric Matrix

The polymeric matrix material of the inventive ESD safe composition can comprise any polymer or mixture of polymers suitable for use in an ESD safe composition. In one aspect, the polymer matrix can comprise one or more thermoplastic materials. In various aspects, the polymeric matrix can comprise one or more of a polycarbonate, polyamide, a nylon, a polypropylene, a polyethylene, a polyetherimide, a polyetheretherketone, and/or derivatives and combinations thereof. In a specific aspect, the polymeric matrix comprises a polycarbonate, such as, for example, bisphenol A polycarbonate. In another aspect, the polymeric matrix can comprise a polyamide, such as, for example, a nylon.

In one aspect, the polymeric matrix can comprise any portion of the inventive ESD safe composition, up to, for example, about 99% or more. In other aspects, the polymeric matrix can comprise the remaining portion of an ESD safe composition, aside from the conductive fiber, conductive powder, and any other additives that can optionally be present. In another aspect, the polymer matrix comprises a single thermoplastic material or a single polymer, and is not a blend of multiple polymers. In another aspect, the polymer matrix is a blend of two or more individual polymer components.

### Conductive Fiber

The inventive ESD safe composition comprises a conductive fiber. In one aspect, the conductive fiber can comprise any conductive fiber suitable for use in an ESD safe composition. In one aspect, the conductivity of a conductive fiber can vary, and range for example, from conductive to semi-conductive. It is not necessary that the conductive fiber have a specific conductivity as long as it can effectively dissipate and/or conduct at least a portion of a charge thereon. In another aspect, the conductive fiber is sufficiently conductive so as to prevent the accumulation of a tribocharge on a surface thereof.

The chemical composition of a conductive fiber can vary and the present invention is not limited to any particular conductive fiber. In one aspect, the conductive fiber or a portion thereof comprises a carbon fiber, such as, for example, a Toho Tenax A HT C483 6 mm fiber. Similarly, the surface chemistry of the conductive fiber can vary, for example, to improve dispersion and/or compatibility with a polymeric matrix or other component of the ESD safe composition, and the present invention is not limited to any particular conductive fiber surface chemistry.

The morphology of a conductive fiber can vary and the present invention is not limited to any particular carbon fiber morphology. In another aspect, the conductive fiber or a portion thereof can have an aspect ratio greater than about 10, for example, about 10, 12, 14, 16, 18, 20, 25, 50, 75, 100, 200, or more. In yet another aspect, the conductive fiber or a portion thereof can having a diameter of from about 1 μm to about 50 μm, for example, about 1, 2, 3, 4, 5, 7, 9, 11, 13, 15, 17, 19, 21, 23, 25, 27, 29, 31, 33, 35, 37, 39, 41, 43, 45, 47, 49, or 50 μm. In other aspects, the conductive fiber or a portion thereof can have a diameter less than about 1 μm or greater than about 50 μm, and the present invention is not intended to be limited to any particular diameter conductive fiber.

The amount of conductive fiber present in the ESD safe composition can vary and can comprise any amount suitable for use in an ESD application. In one aspect, the conductive fiber can comprise up to about 25 wt. % of the ESD safe composition, for example, about 0.2, 0.5, 1, 2, 3, 4, 5, 6, 7, 8, 9, 10, 11, 12, 13, 14, 15, 16, 17, 18, 19, 20, 21, 22, 23, 24, or 25 wt. % of the composition. In other aspects, the conductive fiber can comprise from about 5 wt. % to about 20 wt. % of the composition, or from about 10 wt. % to about 15 wt. % of the composition. In still other aspects, the conductive fiber can comprise less than about 0.2 wt. % or greater than about 25 wt. % of the composition, and the present invention is not intended to be limited to any particular concentration of conductive fiber.

In one aspect, the conductive fiber can be uniformly or substantially uniformly distributed throughout the polymer matrix. In another aspect, the conductive fiber can be dispersed in the polymer matrix such that a higher portion of the conductive fiber is positioned in one portion of the polymer matrix.

### Carbon Powder

The inventive ESD safe composition comprises a conductive powder. In one aspect, the conductive powder can comprise any conductive powder suitable for use in an ESD safe composition. In one aspect, the conductivity of a conductive powder can vary, and range for example, from conductive to semi-conductive. It is not necessary that the conductive powder have a specific conductivity as long as it can effectively dissipate and/or conduct at least a portion of a charge thereon. In another aspect, the conductive powder is sufficiently conductive so as to prevent the accumulation of a tribocharge on a surface thereof.

The chemical composition of a conductive powder can vary and the present invention is not limited to any particular conductive powder. In one aspect, the conductive powder or a portion thereof comprises a carbon powder, such as, for example, carbon black. In another aspect, the conductive powder comprises a particulate carbonaceous powder, such as, for example, a furnace carbon black, a thermal black, a graphite, a Ketjenblack, a heat treated carbon black, a surface modified carbon black, or a combination thereof. In one aspect, the conductive powder comprises a carbon black. In another aspect, the conductive powder comprises a Ketjenblack, such as, for example, Ketjenblack EC-300. In another aspect, the conductive powder comprises an Ensaco 250 carbon black. Similarly, the surface chemistry of the conductive powder can vary, for example, to improve dispersion and/or compatibility with a polymeric matrix or other component of the ESD safe composition, and the present invention is not limited to any particular conductive powder surface chemistry.

Carbon black is of special interest in numerous applications in the electronic industry due to its good conductivity and low cost; however, carbon black can often leave particulate residue from a filled polymer onto a component lead or wafer surface, whereas other conductive fillers, such as carbon fibers, are less likely to contaminate contact surfaces in this way. An added advantage of carbon fiber fillers is that they dramatically increase the flexural modulus of the molded component. This increase in modulus results in better structural support of sensitive components; however, carbon fiber can be very expensive and incorporation of carbon fiber can increase the raw material cost of the composite. At the same time, high carbon fiber loadings can provide a rough surface on molded parts, limiting or adversely affecting certain applications.

The particle size and/or morphology of a conductive powder can vary and the present invention is not limited to any particular carbon powder particle size and/or morphology. In another aspect, the conductive powder or a portion thereof can have an average primary particle size of from about 0.1 μm to about 5 μm, for example, about 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, or 5 μm. In other aspects, the conductive powder can have an average primary particle size of less than about 0.1 μm or greater than about 5 μm, and the present invention is not limited to any particular conductive powder particle size.

The amount of conductive powder present in the ESD safe composition can vary and can comprise any amount suitable for use in an ESD application. In one aspect, the conductive powder can comprise up to about 10 wt. % of the ESD safe composition, for example, about 0.1, 0.2, 0.3, 0.4, 0.5, 0.6, 0.7, 0.8, 0.9, 1, 1.1, 1.2, 1.3, 1.4, 1.5, 1.7. 1.9, 2.1, 2.3. 2.5, 2.7. 2.9, 3, 3.5, 4, 4.5, 5, 5.5, 6, 6.5, 7, 7.5, 8, 8.5, 9, 9.5, or 10 wt. % of the composition. In other aspects, the conductive powder can comprise from about 0.2 wt. % to about 5 wt. % of the composition, or from about 1 wt. % to about 5 wt. % of the composition. In still other aspects, the conductive powder can comprise less than about 0.1 wt. % or greater than about 10 wt. % of the composition, and the present invention is not intended to be limited to any particular concentration of conductive powder.

In one aspect, the conductive filler can be uniformly or substantially uniformly distributed throughout the polymer matrix. In another aspect, the conductive filler can be dispersed in the polymer matrix such that a higher portion of the conductive filler is positioned in one portion of the polymer matrix.

In one aspect, the amount of conductive filler (i.e., conductive fiber and conductive powder) needed to impart a desired level of conductivity to a polymer can vary depending on the composition and morphology of a particular filler. This threshold amount of conductive filler is referred to as the percolation threshold.

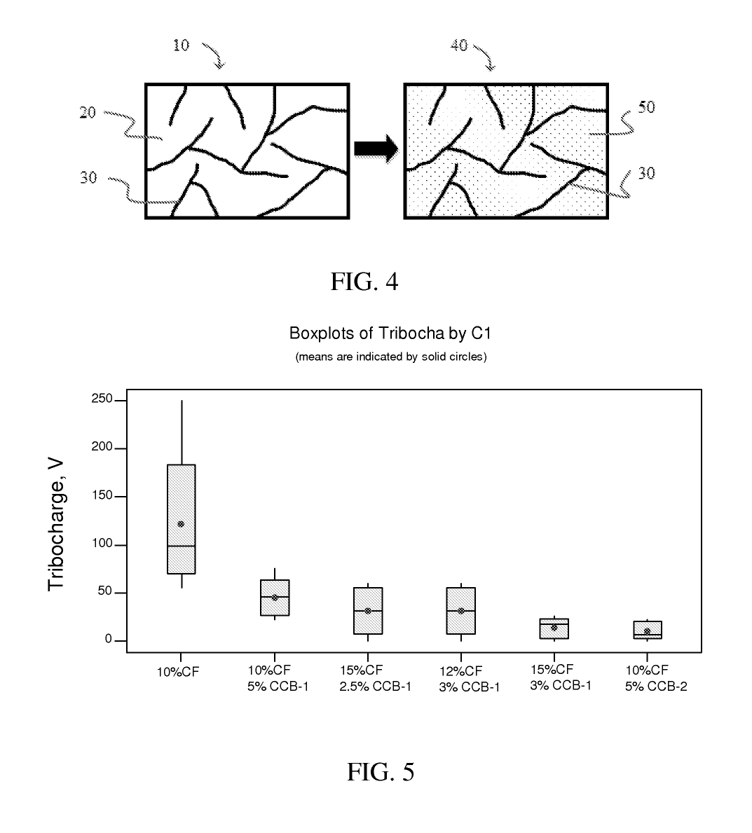

While not wishing to be bound by theory, it is believed that the lower tribocharge of the inventive ESD safe composition is due to the small particle size and large surface area of the conductive powder, enabling it to fill in at least a portion of the spaces in the conductive fiber network. In another aspect, the movement of electrons in a polymeric material can occur via a variety of mechanisms, for example by tunneling and hopping. The high aspect ratio of conductive fibers can facilitate rapid transport of electrons via a tunneling or surface conduction mechanism, but upon contact with the polymeric matrix, electrons must jump through the polymeric matrix to an adjacent conductive or semi-conductive material. The addition of conductive powder, even at relatively low levels, in the polymeric matrix can reduce the distance that electrons must jump in order to move through the material, thus increasing conductivity and reducing the likelihood of accumulation of a tribocharge. FIG. 4 illustrates a first composition 10 comprising a polymeric matrix 20 loaded with conductive fibers 30. FIG. 4 also illustrates a second composition 40 comprising both conductive fibers 30 and conductive powder 50 dispersed within the polymeric matrix.

In one aspect, the inventive ESD safe composition can exhibit a surface resistivity of from about 10³ to about 10¹¹ ohm-meters, for example, about 10³, 10⁴, 10⁵, 10⁶, 10⁷, 10⁸, 10⁹, 10¹⁰, or 10¹¹ ohm-meters. In another aspect, the inventive ESD safe composition can exhibit a surface resistivity of from about 10⁵ to about 10¹¹ ohm-meters, for example, about 10⁵, 10⁶, 10⁷, 10⁸, 10⁹, 10¹⁰, or 10¹¹ ohm-meters. In another aspect, the inventive ESD safe composition can exhibit a surface resistivity of from about 10³ to about 10⁸ ohm-meters, for example, about 10³, 10⁴, 10⁵, 10⁶, 10⁷, or 10⁸ ohm-meters. In yet another aspect, the inventive ESD safe composition can exhibit a surface resistivity of from about 10⁵ to about 10⁸ ohm-meters, for example, about 10⁵, 10⁶, 10⁷, or 10⁸ ohm-meters. In one aspect, the surface resistivity of a composition can be related to molding parameters, such as, for example, mold tool temperature, melting temperature, and/or injection speed. In one aspect, a higher mold temperature can result in a higher surface resistivity.

In still other aspects, the inventive ESD safe composition can optionally comprise one or more other materials, such as, for example, impact modifiers, processing aids, flame retardants, and/or antioxidant materials.

While typical aspects have been set forth for the purpose of illustration, the foregoing descriptions should not be deemed to be a limitation on the scope of the invention. Accordingly, various modifications, adaptations, and alternatives can occur to one skilled in the art without departing from the spirit and scope of the present invention.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Preparation of ESD Samples

In a first example, samples were prepared using one or more of the following raw materials, each commercially available: polycarbonate resin (CAS #111211-39-3), Toho Tenax HT C483 carbon fiber (CAS #7440-44-0), Ketjen carbon powder (CAS #1333-86-4), ENSACO® 250 carbon powder (CAS #1333-86-4), and pentaerythritol tetrastearate (CAS #

Samples were compounded using a Toshiba SE37mm twin screw extruder, wherein the carbon fiber was introduced in zone 7. The remaining components were introduced at the main throat of the extruder (i.e., upstream). Additives were pre-blended with the base resin using a superblender prior to introduction. Compounding and extrusion conditions are detailed in Table 1, below.

TABLE 2
Compounding and Extrusion Conditions

| Parameters | Units | Settings |
|---|---|---|
| Compounder Type | — | Toshiba TEM-37BS |
| Barrel Size | mm | 1500 |
| Die | mm | 4 |
| Zone 1 Temp | ° C. | 50 |
| Zone 2 Temp | ° C. | 100 |
| Zone 3 Temp | ° C. | 250 |
| Zone 4 Temp | ° C. | 260 |
| Zone 5 Temp | ° C. | 270 |
| Zone 6 Temp | ° C. | 270 |
| Zone 7 Temp | ° C. | 270 |
| Zone 8 Temp | ° C. | 270 |
| Zone 9 Temp | ° C. | 270 |
| Zone 10 Temp | ° C. | 270 |
| Zone 11 Temp | ° C. | 270 |
| Die Temp | ° C. | 275 |
| Screw speed | rpm | 300 |
| Throughput | kg/hr | 40 |
| Vacuum | MPa | −0.08 |
| Side Feeder speed | rpm | 300 |
| Side feeder1 | Note | barrel 7 |

The compounded and extruded samples were then molded according to the conditions detailed in Table 2, below. Pellets of each sample were collected for subsequent ESD testing.

TABLE 2
Molding Conditions

| Parameter | Unit | Settings |
|---|---|---|
| Cnd: Pre-drying time | Hour | 4 |
| Cnd: Pre-drying temp | ° C. | 100 |
| Hopper temp | ° C. | 50 |
| Zone 1 temp | ° C. | 300 |
| Zone 2 temp | ° C. | 320 |
| Zone 3 temp | ° C. | 320 |
| Nozzle temp | ° C. | 320 |
| Mold temp | ° C. | 90 |
| Screw speed | rpm | 100 |
| Back pressure | kgf/cm² | 30 |
| Cooling time | s | 20 |
| Molding Machine | NONE | FANUC |
| Shot volume | mm | 84 |
| Injection speed(mm/s) | mm/s | 60 |
| Holding pressure | kgf/cm² | 800 |
| Max. Injection pressure | kgf/cm² | 1000 |

The formulation for the sample specimens are detailed in Table 3, below.

TABLE 3
typical properties of carbon fiber/carbon black hybrid filler filled Polycarbonates

| Item Description | 0 | 1 | 2 | 3 | 4 | 5 | 6 | 7 | 8 | 9 | 10 |
|---|---|---|---|---|---|---|---|---|---|---|---|
| PCP 1300, % | 23.93 | 63 | 63 | 63 | 63 | 63 | 63 | 63 | 63 | 63 | 65.3 |
| 100 GRADE PCP, % | 75.57 | 20.9 | 20.9 | 20.9 | 20.9 | 20.9 | 20.9 | 20.4 | 19.9 | 18.4 | 16.4 |
| Pentaerythritol tetrastearate, % | 0.2 | 0.1 | 0.1 | 0.1 | 0.1 | 0.1 | 0.1 | 0.1 | 0.1 | 0.1 | 0.3 |
| Carbon Black, Medium Color | 0.3 | 0.2 | | | | | | | | | |
| Powder, % | | | | | | | | | | | |
| Ketjenblack EC-300J, % | | | 1 | 2.5 | 3.7 | 5 | | 2 | 1 | 2.5 | 2.5 |
| Ensaco 250G Conductive | | | | | | | 5 | | | | |
| Carbon Black, % | | | | | | | | | | | |
| Toho Tenax A HT C483 | | 16 | 15 | 13.5 | 12.5 | 11 | 11 | 14.5 | 16 | 16 | 15.5 |
| 6 mm, % | | | | | | | | | | | |

2. ESD EVALUATION

In a second example, the ESD properties of the samples prepared in Example 1 were evaluated. ESD performance was evaluated in terms of surface resistivity, tribo-charge & static decay for injection-molded parts. Surface resistivity and static decay were evaluated according to ASTM standard method; tribo-charge was evaluated as below methods:

Tribocharge was measured utilizing an internal test method as described herein. Each sample specimen was rubbed by a PTFE slider under mechanical control for 20 seconds (the PTFE slider moves forward & backward on the surface of the test specimen at a speed of 60 cycles/min and at the same time, rotates at a speed of 80 rpm/min), and then the tribocharge was measured with a test probe in 0.1 second.

Some samples were also evaluated using an external test method which comprised rubbing the test specimen five times with a finger on the surface of an extruded part while wearing Nitrile gloves. The tribocharge was then measured using a test probe.

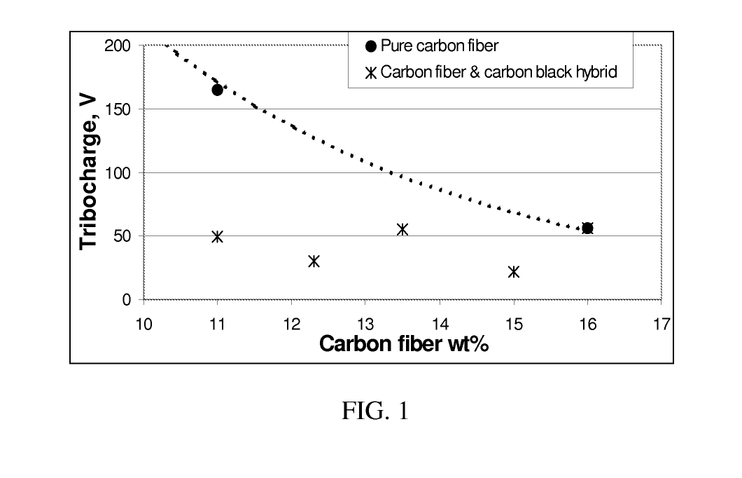

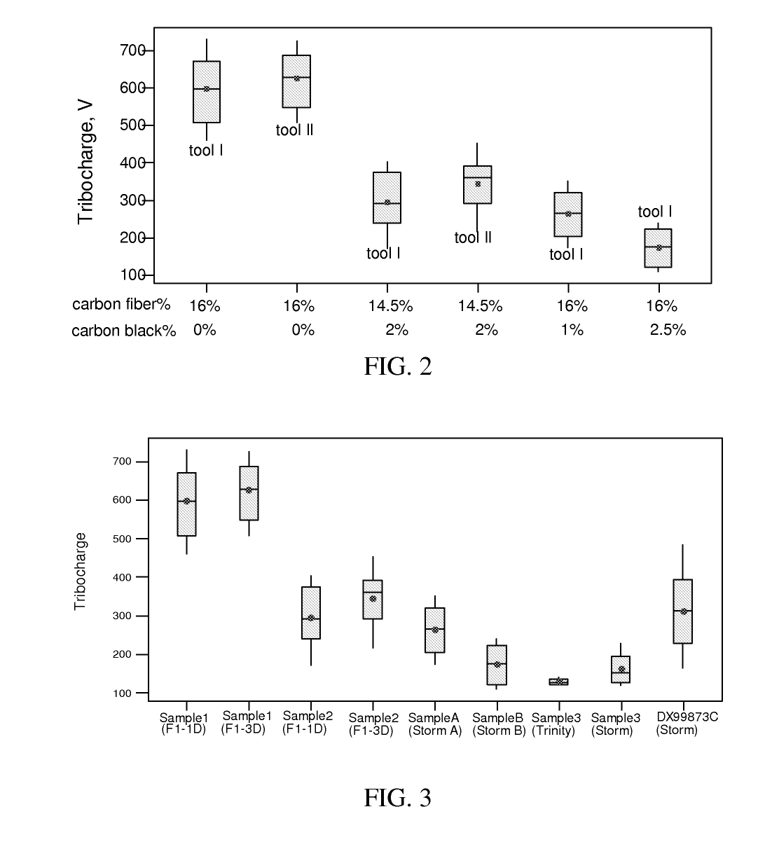

Typical properties of carbon fiber/carbon black hybrid filler filled Polycarbonates were listed in Table 4. The curve of tribocharge versus carbon fiber weight percentage based on the internal test method is illustrated in FIG. 1, whereas test results based on the external test method are illustrated in FIG. 2. At the same carbon fiber loading, samples that contain carbon powder (e.g., carbon black) exhibited lower tribocharge, as illustrated in Table 4, FIG. 1, and FIG. 2.

TABLE 4
Properties of Carbon fiber/Carbon black filled Polycarbonates

| | Test | | | | | | |
|---|---|---|---|---|---|---|---|
| Test | Description | Unit | 0 | 1 | 2 | 3 | 4 |
| Modulus of | ASTM | MPa | X | 10551.8 | 10018.8 | 8891.6 | 8693 |
| Elasticity | D638 | | | | | | |
| Stress at Break | ASTM | MPa | X | 131.6 | 129.4 | 120.6 | 120.4 |
| | D638 | | | | | | |
| Elongation at | ASTM | % | X | 2.7 | 2.8 | 2.8 | 2.9 |
| Break | D638 | | | | | | |
| Flexural Modulus | ASTM | MPa | X | 9370 | 8990 | 8420 | 7750 |
| | D790 | | | | | | |
| Flexural | ASTM | MPa | X | 202 | 200 | 197 | 190 |
| Stress@Yield | D790 | | | | | | |
| Flexural | ASTM | MPa | X | 200 | 198 | 196 | 190 |
| Stress@Break | D790 | | | | | | |
| Impact Strength | ASTMD | J/m | X | 80.9 | 79.4 | 75.6 | 71.9 |
| | 256, notched | | | | | | |
| MVR, 300° C., | ASTM | cm³/10 min | 16.2 | 13.7 | 12 | 9.2 | 8.55 |
| 2.16 Kg | D1238, | | | | | | |
| Impact Strength | ASTM | J/m | X | 593 | 621 | 598 | 600 |
| | D256 | | | | | | |
| Deflection temp | ASTM | ° C. | X | 146 | 147 | 147 | 147 |
| | D648 | | | | | | |
| Density | ASTM | — | X | 1.2607 | 1.2596 | 1.2574 | 1.2569 |
| | D792 | | | | | | |
| Surface | ASTM | OHM-P-SQ | 2E+15 | 17000 | 18000 | 21000 | 23000 |
| Resistivity | D257 | | | | | | |
| Static Decay | ASTM | s | >10 | <0.1 | <0.1 | <0.1 | <0.1 |
| Tribocharge | Internal Test | v | 2140 | 56 | 22 | 55 | 30 |
| | Method | | | | | | |
| | External | v | | 597.4 | | | |
| | Test Method | | | | | | |

| Test | 5 | 6 | 7 | 8 | 9 | 10 |
|---|---|---|---|---|---|---|
| Modulus of | 7989.4 | 8044.2 | 9603.2 | X | X | X |
| Elasticity | | | | | | |
| Stress at Break | 113.6 | 114.4 | 122.6 | X | X | X |
| Elongation at | 3.2 | 3.1 | 2.9 | X | X | X |
| Break | | | | | | |
| Flexural Modulus | 7110 | 7210 | 8110 | X | X | X |
| Flexural | 185 | 183 | 192 | X | X | X |
| Stress@Yield | | | | | | |
| Flexural | 184 | 183 | 192 | X | X | X |
| Stress@Break | | | | | | |
| Impact Strength | 68.4 | 72.9 | 72.3 | X | X | X |
| MVR, 300° C., | 14.7 | 15.6 | 14.1 | X | X | X |
| 2.16 Kg | | | | | | |
| Impact Strength | 630 | 631 | 605 | X | X | X |
| Deflection temp | 147 | 146 | 145 | X | X | X |
| Density | 1.2558 | 1.2616 | 1.2625 | X | X | X |
| Surface | 30000 | 36000 | 14534 | X | X | X |
| Resistivity | | | | | | |
| Static Decay | <0.1 | <0.1 | <0.1 | <0.1 | <0.1 | <0.1 |
| Tribocharge | 49 | 165 | X | X | X | X |
| | | | 294.6 | 264.4 | 173.3 | 162.6 |

The measured tribocharge was significantly lower for polycarbonate materials loaded with a small amount of conductive carbon powder, such as, for example, carbon black.

3. Preparation and Evaluation of Polyamide Samples

In a third example, samples using a polyamide base polymer were prepared and evaluated for ESD properties as described in the previous Examples. The composition of each of the polyamide containing samples is detailed in Table 5, below.

TABLE 5
Composition of Polyamide Containing Samples

| Item Description | 1 | 2 | 3 | 4 | 5 | 6 |
|---|---|---|---|---|---|---|
| PA66 Regular HV, % | 74.45 | 69.45 | 66.95 | 69.45 | 66.45 | 69.45 |
| Phosphate Stabilizer, % | 0.15 | 0.15 | 0.15 | 0.15 | 0.15 | 0.15 |
| Phenolic prim antioxidant | 0.2 | 0.2 | 0.2 | 0.2 | 0.2 | 0.2 |
| for PA, % | | | | | | |
| Lonza Acrawax C Beads, % | 0.2 | 0.2 | 0.2 | 0.2 | 0.2 | 0.2 |
| PA6 Regular - NV | 15 | 15 | 15 | 15 | 15 | 15 |
| HAEG, % | | | | | | |
| SGL SIGRAFIL C25 | 10 | 10 | 15 | 12 | 15 | 10 |
| S006 PUT, % | | | | | | |
| KETJENBLACK EC-300J, % | | 5 | 2.5 | 3 | 3 | |
| Ensaco 250G | | | | | | 5 |
| Conductive Carbon Black, % | | | | | | |

The polyamide containing samples were evaluated as described above, and the resulting values outlined in Table 6, below.

TABLE 6
Properties of Polyamide Containing Samples

| Typical | | | | | | | | |
|---|---|---|---|---|---|---|---|---|
| Properties | Test Method | Units | 1 | 2 | 3 | 4 | 5 | 6 |
| Modulus of | ASTM D638 | MPa | | 8313.2 | 11445.4 | 9719.4 | 11268.4 | 8469.6 |
| Elasticity | | | | | | | | |
| Stress at Break | ASTM D638 | MPa | | 126.4 | 166.2 | 151.4 | 166 | 138.4 |
| Elongation at | ASTM D638 | % | | 2.4 | 3.3 | 3 | 3.2 | 3 |
| Break | | | | | | | | |
| Flexural | ASTM D790 | MPa | | 6220 | 8520 | 7320 | 8350 | 6200 |
| Modulus | | | | | | | | |
| Flexural | ASTM D790 | MPa | | 209 | 252 | 229 | 250 | 205 |
| Stress@Break | | | | | | | | |
| Impact Strength | ASTMD | J/m | | 34.8 | 54.5 | 42.2 | 52.8 | 36.4 |
| | 256, notched | | | | | | | |
| MVR, 300° C., | ASTM | cm³/10 | | 33.7 | 35.6 | 37.7 | 30.3 | 37.4 |
| 2.16 Kg | D1238, | min | | | | | | |
| Impact Strength | ASTM | J/m | | 315 | 501 | 378 | 515 | 391 |
| | D256, | | | | | | | |
| | unnotched | | | | | | | |
| Deflection temp | ASTM D648 | ° C. | | 253 | 256 | 255 | 256 | 254 |
| Density | ASTM D792 | — | | 1.1995 | 1.2093 | 1.1993 | 1.2112 | 1.1992 |
| Surface | ASTM D257 | OHM-P- | 2.8E+14 | 1.2E+05 | 2.4E+06 | 1.6E+05 | 3.6E+05 | 1.2E+05 |
| Resistivity | | SQ | | | | | | |
| Tribo-charge | Internal Test | V | 121 | 45 | 37 | 31 | 13 | 10 |
| | method | | | | | | | |

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electrostatic discharge safe composition comprising:
a. a polymeric matrix; and
b. a combination of one or more conductive fibers and one or more conductive powders.

2. The composition of claim 1, wherein the polymeric matrix comprises a polycarbonate, a polyamide, a nylon, a polypropylene, a polyethylene, a polyetherimide, a polyetheretherketone, and/or derivatives and combinations thereof.

3. The composition of claim 1, wherein at least a portion of the one or more conductive fibers comprises a carbon fiber.

4. The composition of claim 1, wherein at least a portion of the one or more conductive fibers has an aspect ratio of greater than about 10 and a diameter of from about 1 μm to about 50 μm.

5. The composition of claim 1, wherein at least a portion of the one or more conductive powders comprise a carbon powder.

6. The composition of claim 1, wherein at least a portion of the one or more conductive powders comprises a furnace carbon black, a thermal black, a graphite, a Ketjenblack, a heat treated carbon black, a surface modified carbon black, or a combination thereof.

7. The composition of claim 1, wherein at least a portion of the conductive powder has an average primary particle size of from about 0.1 μm to about 5 μm.

8. The composition of claim 1, having a surface resistivity of from about 10³ to about 10¹¹ ohm-meters

9. The composition of claim 1, having a surface resistivity of from about 10⁵ to about 10¹¹ ohm-meters.

10. The composition of claim 1, having a surface resistivity of from about 10³ to about 10⁸ ohm-meters.

11. The composition of claim 1, having a surface resistivity of from about 10⁵ to about 10⁸ ohm-meters.
